(19) United States
(12) Patent Application Publication
(10) Pub. No.: US 2024/0342846 A1
(43) Pub. Date: Oct. 17, 2024

(54) LEAD SUPPLY SYSTEM AND METHOD FOR CONTROLLING THE SAME

(71) Applicant: LG ENERGY SOLUTION, LTD., Seoul (KR)

(72) Inventors: Ju Hwan BAEK, Daejeon (KR); Won Seok CHOI, Daejeon (KR); Duk Keun OH, Daejeon (KR); Seung Bae LEE, Daejeon (KR); Seok In HONG, Daejeon (KR); Seung Jin HWANG, Daejeon (KR)

(73) Assignee: LG ENERGY SOLUTION, LTD., Seoul (KR)

(21) Appl. No.: 18/682,270

(22) PCT Filed: Aug. 29, 2022
(86) PCT No.: PCT/KR2022/012856

§ 371 Date: Feb. 8, 2024

(30) Foreign Application Priority Data
Sep. 2, 2021 (KR) 10-2021-0117116

(51) Int. Cl. B23Q 7/04; H01M 10/04

(52) U.S. Cl. CPC B23Q 7/04; H01M 10/0409

(57) ABSTRACT

A lead supply system according to an embodiment of the present invention may supply the lead so as to be connected to an electrode tab. The lead supply system may include: a seating part on which the lead is seated; a vision sensor that photographs the lead at an upper side of the seating part; an alignment mechanism that adjusts the seating part so as to align the lead on the basis of vision data photographed by the vision sensor; and a supply device that picks up the lead from the seating part so as to supply the lead to a position at which the lead is connected to the electrode tab.

### CROSS-REFERENCE TO RELATED APPLICATION

The present application claims the benefit of the priority of Korean Patent Application No. 10-2021-0117116, filed on Sep. 2, 2021, which is hereby incorporated by reference in its entirety.

### TECHNICAL FIELD

The present invention relates to a lead supply system and a method for controlling the same, and more particularly, to a lead supply system, which supplies a lead so as to be connected to an electrode tab provided in a cell, and a method for controlling the lead supply system.

### BACKGROUND ART

In general, secondary batteries refer to batteries that are chargeable and dischargeable unlike non-rechargeable primary batteries, and are widely used in electronic devices such as mobile phones, notebook computers, and camcorders, or electric vehicles, etc. In particular, a lithium secondary battery has a larger capacity and a higher energy density per unit weight than a nickel-cadmium battery or a nickel-hydrogen battery, and thus utilization thereof is on a rapidly increasing trend.

The lithium secondary battery may be also classified according to the configuration of an electrode assembly in a positive electrode/separator/negative electrode structure.

Representative examples may include a jelly-roll-type electrode assembly in a configuration where long sheet-shaped positive electrodes and negative electrodes are wound with a separator interposed therebetween, a stacked type electrode assembly in which a plurality of positive and negative electrodes cut into units having a predetermined size are stacked in sequence with a separator interposed therebetween, and a stacked/folded type electrode assembly in a configuration where bi-cells or full-cells are wound which have positive and negative electrodes in a predetermined unit stacked with a separator interposed therebetween, and so on.

Recently, a secondary battery cell, which has a structure in which the stacked type or stacked/folded type electrode assembly is embedded in a pouch type battery case made of an aluminum laminate sheet, attracts a lot of interest for reasons such as low manufacture cost, small weight, and easy change in shape, and use thereof also gradually increases.

In such a lithium secondary battery, a lithium-based oxide and a carbon material are mainly used as a positive electrode active material and a negative electrode active material, respectively. The lithium secondary battery is provided with an electrode assembly, in which a plurality of electrodes coated respectively with the electrode active materials are disposed with a separator therebetween, and an exterior material which seals and accommodates the electrode assembly together with an electrolyte.

FIG. 1 is a perspective view of a general electrode assembly.

An electrode assembly 10 is provided with a plurality of electrode tabs 20 extending from a plurality of electrodes, and each of the plurality of electrode tabs 20 is bonded to a lead 30 by welding. Here, the plurality of electrode tabs 20 may include a plurality of positive electrode tabs extending from a plurality of positive electrodes, and a plurality of negative electrode tabs extending from a plurality of negative electrodes. The lead 30 connected to the plurality of positive electrode tabs may be a positive electrode lead, and the lead 30 connected to the plurality of negative electrode tabs may be a negative electrode lead. FIG. 1 illustrates the electrode assembly 10 in which the positive electrode tab and the negative electrode tab protrude in opposite directions. However, the electrode assembly 10 is not limited thereto, and may also have a configuration in which the positive electrode tab and the negative electrode tab protrude in the same direction.

A process of bonding the electrode tab 20 to the lead 30 includes supplying the lead 30 to a position at which the lead 30 is connected to the electrode tabs 20, and welding the electrode tab 20 to the lead 30 at the position.

In this regard, according to the related art, when the dimension or type of the lead 30 changes, a worker manually adjusts settings, etc., of equipment so as to supply the lead 30 at a predetermined position in the supplying of the lead 30. However, there is a limit to such adjustment in that accuracy is reduced and it needs to be performed in a state in which the equipment is stopped.

### DISCLOSURE OF THE INVENTION

### Technical Problem

An object of the present invention for solving the above problems is to provide a lead supply system, which automatically accurately aligns the lead so as to be connected to an electrode tab, and a method for controlling the lead supply system.

### Technical Solution

A lead supply system according to an embodiment of the present invention may supply the lead to be connected to an electrode tab. The lead supply system may include: a seating part on which the lead is seatable; a vision sensor configured to photograph the lead at an upper side of the seating part; an alignment mechanism configured to adjust the seating part to align the lead on the basis of vision data photographed by the vision sensor; and a supply device configured to pick up the lead from the seating part to supply the lead to a position at which the lead is to be connected to the electrode tab.

The lead supply system may further include a collecting box in which the lead is collected by the supply device when the lead is determined to be defective or to be inappropriate for the electrode tab on the basis of the vision data.

The alignment mechanism may include a rotation motor, which is disposed below the seating part and configured to rotate the seating part around a vertical axis, and an orthogonal robot configured to move the rotation motor horizontally in first and second directions perpendicularly crossing each other.

The alignment mechanism may be configured to move the seating part between a standby position disposed below the vision sensor and a supply position spaced apart from the standby position in a first direction. The supply device may be configured to pick up the lead when the seating part is disposed at the supply position.

The supply device may include a gripper that holds the lead, and an orthogonal robot that moves the gripper in a second direction perpendicularly crossing the first direction and in a vertical direction.

The lead supply system may further include a loading device configured to load the lead on the seating part when the seating part is disposed at the standby position.

The loading device may include an adherence part configured to adhere the lead at an upper side of the adherence part, an elevation actuator configured to elevate the adherence part, and a uniaxial actuator configured to move the elevation actuator horizontally.

The lead supply system may further include at least one of an overhead light configured to emit light onto the lead from above the seating part, or a backlight provided in the seating part or disposed below the seating part.

The lead supply system may further include a concentrative light directed toward the seating part and configured to concentratively emit light onto a partial area on the lead.

A method for controlling a lead supply system according to an embodiment of the present invention may include: loading the lead on a seating part; photographing the lead on the seating part by a vision sensor; adjusting the seating part to align the lead on the basis of vision data photographed by the vision sensor; and picking up the lead from the seating part to move the lead to a position at which the lead is connected to the electrode tab.

The method may further include collecting the lead when the lead is determined to be defective or inappropriate for the electrode tab on the basis of the vision data.

The method may further include moving the seating part in a first direction between a location where adjusting the seating part occurs and a location where the picking up the lead occurs.

The picking up the lead may include picking up the lead seated on the seating part by a gripper, and moving the gripper horizontally in a second direction perpendicularly crossing the first direction.

The photographing the lead may be performed in a state in which light is emitted toward the lead.

### Advantageous Effects

According to the preferred embodiments of the present invention, the seating part may be adjusted to align the lead on the basis of the vision data photographed by the vision sensor. Accordingly, the lead may be supplied at the predetermined position at which the lead is connected to the electrode tab, and the quality of the electrode assembly may be improved.

Even when the specification, etc., of the lead to be stocked changes, the alignment of the lead may be automatically performed without stopping the equipment. Accordingly, the productivity of the electrode assembly may increase.

When the lead is determined as a defect or inappropriateness on the basis of the vision data photographed by the vision sensor, the lead may be collected but not supplied. Accordingly, the quality of the electrode assembly may be further improved.

In addition, the effects may be included which could be easily predicted by those skilled in the art from the configurations according to the preferred embodiments of the present invention.

### BRIEF DESCRIPTION OF THE DRAWINGS

FIG. 1 is a perspective view of a general electrode assembly.

FIG. 2 is a schematic diagram of a lead supply system according to an embodiment of the present invention.

FIG. 3 is a control block diagram of the lead supply system according to an embodiment of the present invention.

FIG. 4 is a flowchart of a method for controlling a lead supply system according to an embodiment of the present invention.

FIGS. 5 to 9 are views for explaining operations of the lead supply system according to an embodiment of the present invention.

FIG. 10 is a view for explaining a lead supply system according to another embodiment of the present invention.

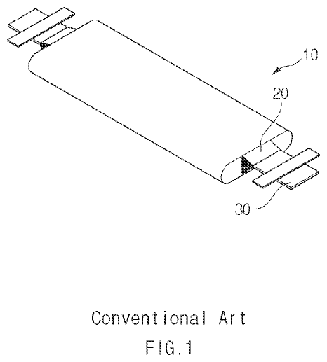

### MODE FOR CARRYING OUT THE INVENTION

Hereinafter, preferred embodiments of the present invention will be described in detail with reference to the accompanying drawings so as to enable those skilled in the art to which the present invention pertains to easily carry out the present invention. The present invention may, however, be embodied in different forms and should not be construed as limited by the embodiments set forth herein.

The parts unrelated to the description, or the detailed descriptions of related well-known art that may unnecessarily obscure subject matters of the present invention, will be ruled out in order to clearly describe the present invention. Like reference numerals refer to like elements throughout the whole specification.

Moreover, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe his or her invention in the best ways.

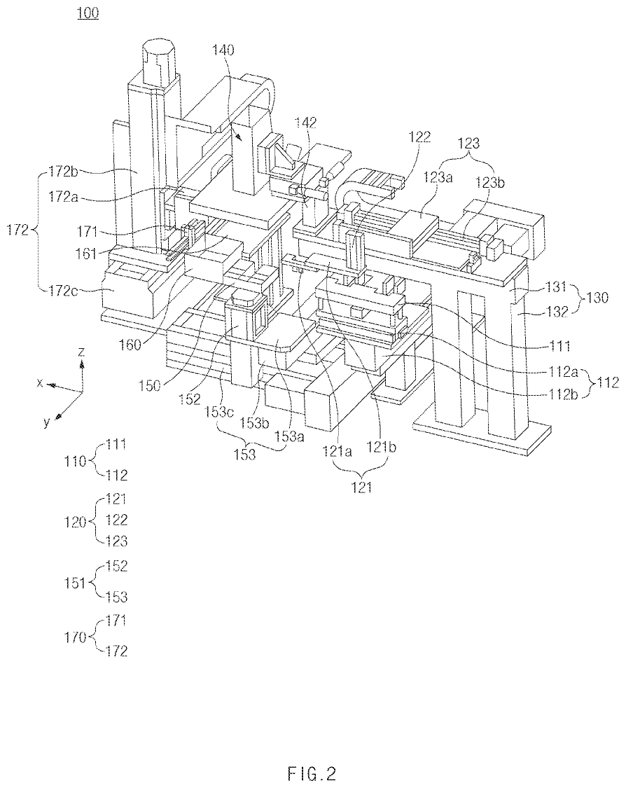

FIG. 2 is a schematic diagram of a lead supply system according to an embodiment of the present invention.

Hereinafter, for convenience of explanation, a direction parallel to an X-axis in FIG. 2 is called a first direction, and a direction parallel to a Y-axis is called a second direction. A Z-axis is parallel to a vertical direction and thus, the first direction and the second direction may be horizontal directions perpendicularly crossing each other.

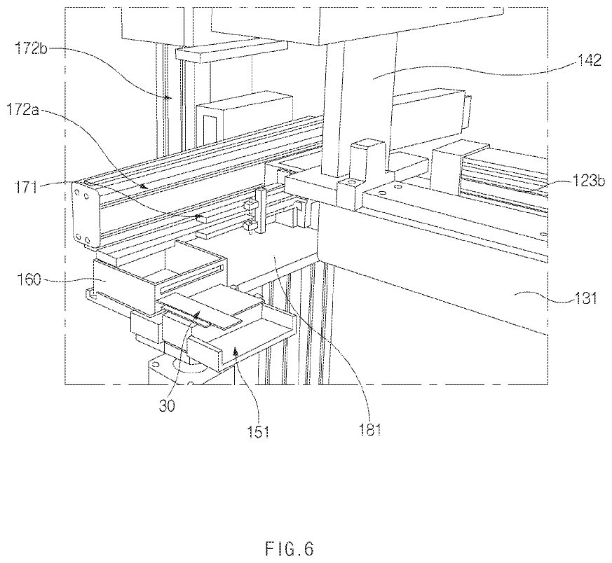

A lead supply system 100 according to an embodiment of the present invention may include a seating part 150 on which a lead 30 (see FIG. 6) is seated, a vision sensor 140 disposed above the seating part 150, an alignment mechanism 151 that adjusts the seating part 150 so as to align the lead 30, and a supply device 170 that picks up the lead 30 from the seating part 150 so as to supply the lead to a preset position.

The lead supply system 100 may further include a loading device 120 that loads the lead 30 on the seating part 150, and a supply buffer 110 that supplies the lead 30 to the loading device 120.

Hereinafter, for convenience of explanation, each of components of the lead supply system 100 will be described according to the transfer order of the lead 30.

The supply buffer 110 may sequentially supply the lead 30 manufactured in a previous process. Here, the lead 30 may be provided in a state in which an insulation film for post-sealing with a pouch type battery case (not shown) is attached to a portion of a circumference of the lead 30.

In more detail, the supply buffer 110 may include a table 111 on which the lead 30 is seated, and a uniaxial actuator 112 that moves the table 111.

The table 111 may be horizontally provided, and at least one lead 30 may be seated on a top surface of the table 111.

The uniaxial actuator 112 may move the table 111 horizontally in the second direction. In more detail, the uniaxial actuator 112 may include a base 112a coupled to a lower side of the table 111, and a guide 112b that guides movement of the base 112a and extends in the second direction. Thus, the table 111 may move in the second direction together with the base 112a. The detailed configuration and operation of the uniaxial actuator 112 are the well-known art and thus, the detailed description thereof will be omitted.

The table 111 may reciprocate, by the uniaxial actuator 112, between an initial position at which the lead 30 is seated, and a supply position spaced apart from the initial position in the second direction. The supply position may be below the loading device 120 to be described later. FIG. 2 illustrates a state in which the table 111 is disposed at the supply position.

Thus, when the table 111 is disposed at the initial position, the lead 30 may be seated on the table 111, and when the table 111, on which the lead 30 is seated, moves to the supply position by the uniaxial actuator 112, the loading device 120 may pick up the lead 30 seated on the table 111 so as to load the lead 30 on the seating part 150.

The loading device 120 may be supported by a support frame 130 so as to be disposed above the supply buffer 110.

The loading device 120 may include an adherence part 121 that adheres the lead 30 at an upper side, an elevation actuator 122 that elevates the adherence part 121, and a uniaxial actuator 123 that moves the elevation actuator 122.

The adherence part 121 may vacuum-adhere the lead 30 on the table 111 of the supply buffer 110. In more detail, the adherence part 121 may include a close-contact part 121a in close contact with a top surface of the lead 30, and a support plate 121b on which the close-contact part 121a is suspended and supported. The close-contact part 121a may be communicated with a flexible pipe connected to a pump (not shown) that generates negative pressure.

The elevation actuator 122 may elevate the adherence part 121 in a vertical direction. The elevation actuator 122 may be connected to the adherence part 121, more particularly to the support plate 121b.

The elevation actuator 122 may allow the adherence part 121 to ascend so as to pick up the lead 30 from the table 111, or allow the adherence part 121 to descend so as to load the lead 30 on the seating part 150.

The uniaxial actuator 123 may be connected to the elevation actuator 122 and move the elevation actuator 122 horizontally in the first direction. In more detail, the uniaxial actuator 123 may include a connection body 123a connected to the elevation actuator 122, and a guide 123b that guides movement of the connection body 123a and extends in the first direction. The detailed configuration and operation of the uniaxial actuator 123 are the well-known art and thus, the detailed description thereof will be omitted.

Thus, the adherence part 121 may move horizontally in the first direction together with the elevation actuator 122. The adherence part 121 may pick up the lead 30 from the table 111 of the supply buffer 110 and move in the first direction by the uniaxial actuator 123 so as to load the lead on the seating part 150.

The support frame 130 may include a frame body 131 that supports the uniaxial actuator 123 of the loading device 120, and a pillar 132 that supports the horizontal frame body 131. The frame body 131 may be elongated in a direction parallel to the uniaxial actuator 123 of the loading device 120, i.e., in the first direction. The pillar 132 may be provided in plurality so as to stably support the frame body 131.

The supply buffer 110 may be disposed to pass below the frame body 131. The adherence part 121 and the elevation actuator 122 of the loading device 120 may be disposed at one side in a width direction of the frame body 131.

The lead 30 transferred by the loading device 120 may be seated on the seating part 150. The seating part 150 may be horizontally disposed.

The alignment mechanism 151 may adjust the seating part 150 so as to align the lead 30. The alignment mechanism 151 may move the seating part 150 horizontally and rotate around a vertical axis.

In more detail, the alignment mechanism 151 may include a rotation motor 152 that rotates the seating part 150 around the vertical axis, and an orthogonal robot 153 that moves the rotation motor 152 horizontally in the first direction and in the second direction.

The rotation motor 152 may be disposed below the seating part 150 and connected to the seating part 150. The rotation motor 152 may precisely adjust an angle of the seating part 150. For example, the rotation motor 152 may be a servo motor.

The orthogonal robot 153 may include a mounting part 153a, on which the rotation motor 152 is mounted, a first guide 153b, which guides movement of the mounting part 153a and is elongated in one direction of the first direction and the second direction, and a second guide 153c which guides movement of the first guide 153b and is elongated in the other direction of the first direction and the second direction. Thus, the seating part 150 may move in the first direction and in the second direction together with the rotation motor 152.

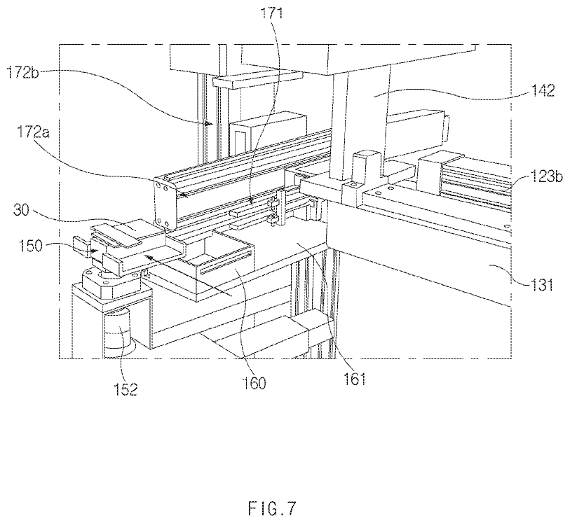

The seating part 150 may move, by the alignment mechanism 151, between a standby position (see FIG. 6) disposed below the vision sensor 140, and a supply position (see FIG. 7) spaced apart from the standby position in the first direction. That is, the alignment mechanism 151, more particularly the orthogonal robot 153, may reciprocate the seating part 150 between the standby position and the supply position. FIG. 2 illustrates a state in which the seating part 150 is disposed at the standby position.

In more detail, when the seating part 150 is disposed at the standby position, the vision sensor 140 may photograph the lead 30 on the seating part 150, and the alignment mechanism 151 may adjust the seating part 150 so as to align the lead 30 on the basis of vision data photographed by the vision sensor 140.

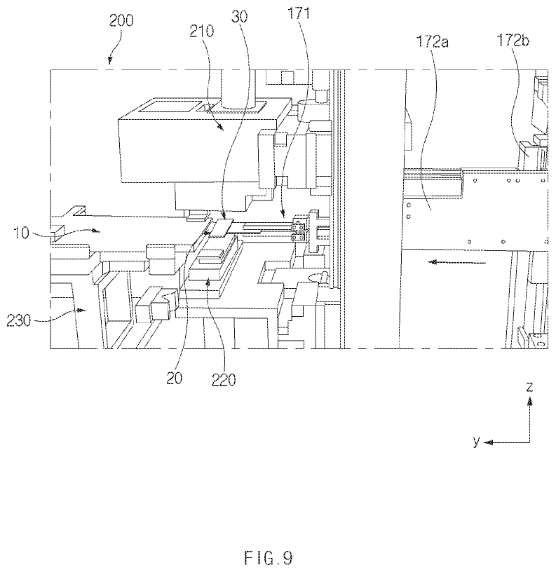

When the alignment of the lead 30 is completed, the alignment mechanism 151 may move the seating part 150 by a preset distance in the first direction, and the seating part 150 may reach the supply position. That is, the supply position is not a fixed position, but may vary slightly according to the alignment of the lead 30. When the seating part 150 moves to the supply position, the supply device 170 may pick up the lead 30 on the seating part 150 so as to supply the lead 30 to a position at which the lead 30 is connected to the electrode tab 20 of an electrode assembly 10 (see FIG. 9).

The vision sensor 140 may photograph the lead 30 at an upper side of the seating part 150. The vision sensor 140 may be disposed above the seating part 150 that is the standby position. For example, the vision sensor 140 may include a camera.

The vision sensor 140 may be supported by the frame body 131 of the support frame 130 descried above. In more detail, a connection part 142 connected to the vision sensor 140 may be coupled to the frame body 131.

The supply device 170 may be disposed to be spaced apart from the loading device 120 in the first direction. That is, the supply device 170 may be disposed at a side opposite to the loading device 120 with the seating part 150 therebetween.

The supply device 170 may include a gripper 171 that holds the lead 30, and an orthogonal robot 172 that moves the gripper 171.

The gripper 171 may hold the lead 30 seated on the seating part 150. In more detail, the gripper 171 may hold the lead 30 on the seating part 150 when the seating part 150 is disposed at the supply position (see FIG. 7) described above.

For example, the gripper 171 may include a pair of holding parts spaced apart from each other in an upward-downward direction, and an actuator that changes a distance between the pair of holding parts. In this case, the lead 30 may be held between the pair of holding parts.

The orthogonal robot 172 may include a first guide 172a that guides movement of the gripper 171 and is elongated in the second direction, and a second guide 172b that guides movement of the first guide 172a and is elongated in the vertical direction. The orthogonal robot 172 may further include a third guide 172c that guides movement of the second guide 172b and is elongated in the second direction. Thus, the orthogonal robot 172 may move the gripper 171 in the second direction and in the vertical direction.

The orthogonal robot 172 may move the gripper 171 in the second direction so that the lead 30 on the seating part 150 is inserted between the pair of holding parts of the gripper 171. In this regard, a groove that prevents an interference to the gripper 171 may be defined in the seating part 150.

The orthogonal robot 172 may allow the gripper 171 holding the lead 30 to ascend so as to pick up the lead 30 from the seating part 150. In a state in which the gripper 171 picks up the lead 30, the orthogonal robot 172 may allow the gripper 171 to move and descend in the second direction so as to supply the lead 30 to the position at which the lead 30 is connected to the electrode tab 20 (see FIG. 9).

The lead supply system 100 may further include a collecting box 160 in which the lead 30 defective or inappropriate is collected.

In more detail, if the vision sensor 140 detects a defect or inappropriateness of the lead 30 when the seating part 150 is disposed at the standby position, the supply device 170 may pick up and drop the lead 30 into the collecting box 160 when the seating part 150 is disposed at the supply position. Thus, the defective or inappropriate lead 30 may be prevented from being supplied to the position at which the lead 30 is connected to the electrode tab 20 (see FIG. 9).

The collecting box 160 may have a top surface opened. The collecting box 160 may be disposed in a lateral direction of the supply device 170. In more detail, the collecting box 160 may be disposed below a point in a movement path of the gripper 171. Thus, when the gripper 171 releases the lead 30 from above the collecting box 160, the lead 30 may be dropped into the collecting box 160.

The collecting box 160 may be supported by a support frame 161 at a height similar to or a slightly lower than the height of the seating part 150. Thus, the lead 30 released from the gripper 171 may stably enter the collecting box 160.

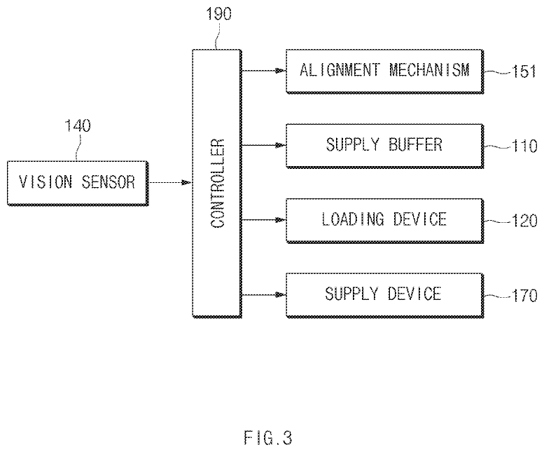

FIG. 3 is a control block diagram of the lead supply system according to an embodiment of the present invention.

The lead supply system 100 according to an embodiment of the present invention may further include a controller 190. The controller 190 may include at least one processor.

The controller 190 may control an overall operation of the lead supply system 100.

The controller 190 may control the supply buffer 110, the loading device 120, and the supply device 170.

The controller 190 may communicate with vision sensor 140 to receive the vision data photographed by the vision sensor 140, and may control the alignment mechanism 151 to align the lead 30 on the basis of the vision data. In more detail, the controller 190 may analyze the vision data to extract an outline of the lead 30, and generate a control command for matching the outline with a predetermined position to deliver the control command to the alignment mechanism 151.

The controller 190 may determine a defect and/or inappropriateness of the lead 30 on the basis of the vision data photographed by the vision sensor 140.

In one example, when one lead 30 is below a predetermined specification or detected to be broken, the one lead 30 may be determined as a defect.

In another example, when the material of one lead 30 does not match the polarity of the electrode tab 20 (see FIG. 9), the one lead 30 may be determined as inappropriateness. In more detail, the controller 190 may analyze the vision data to determine the material of the lead 30 on the basis of the color property (e.g., chroma) of the lead 30, and may determine whether the material of the lead 30 matches polarity information of the electrode tab 20. In this regard, the electrode tab 20 of a negative electrode may match the lead 30 having a nickel or copper material, and the electrode tab 20 of a positive electrode may match the lead 30 including an aluminum material.

When the lead 30 is determined as a defect or inappropriateness, the controller 190 may control the supply device 170 to collect the lead 30 in the collecting box 160. In contrast, when the lead 30 is determined to be normal, the controller 190 may control the supply device 170 to supply the lead 30 to the position at which the lead 30 is connected to the electrode tab 20.

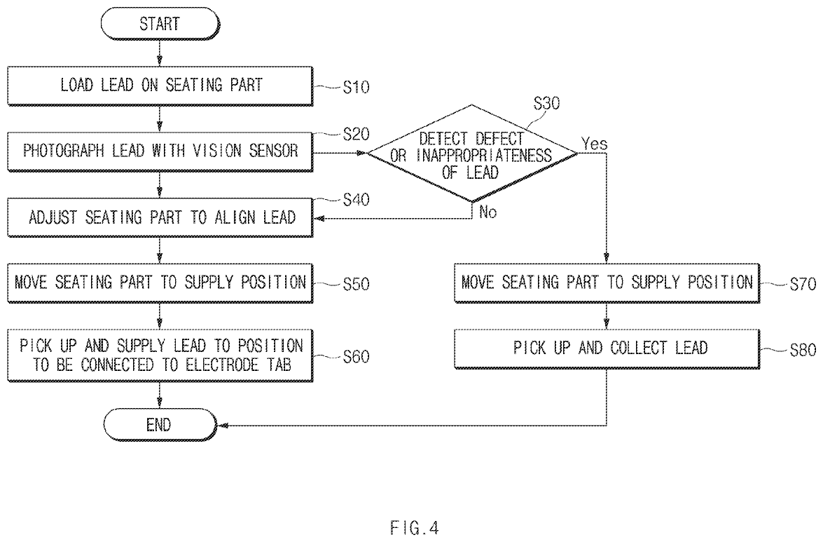

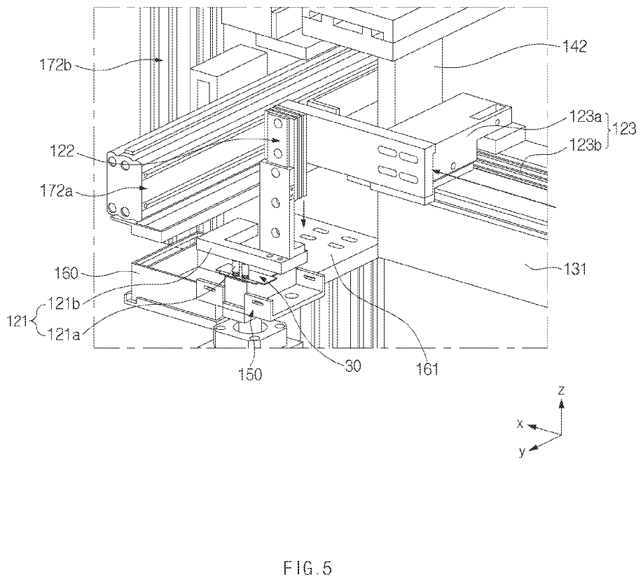

FIG. 4 is a flowchart of a method for controlling a lead supply system according to an embodiment of the present invention. FIGS. 5 to 9 are views for explaining operations of the lead supply system according to an embodiment of the present invention.

A method for controlling a lead supply system according to an embodiment of the present invention (hereinafter referred to as a “control method”) may include a loading process (S10), a sensing process (S20), an alignment process (S40), and a supply process (S60). The control method may further include a moving process (S50 or S70) and a collection process (S80).

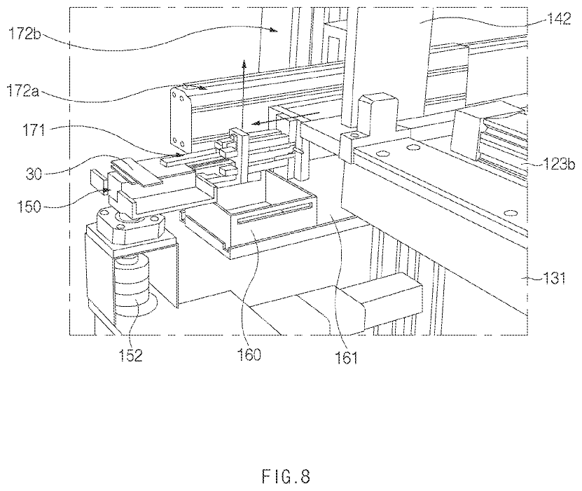

FIG. 5 is a view for explaining the loading process (S10). FIG. 6 is a view for explaining the sensing process (S20) and the alignment process (S40). FIG. 7 is a view for explaining the moving process (S50 or S70). FIG. 8 is a view for explaining a process in which a lead 30 is picked up in the supply process (S60). FIG. 9 is a view for explaining a process in which the lead 30 moves to a position, at which the lead 30 is connected to an electrode tab 20, in the supply process (S60).

Hereinafter, the respective operations will be described in more detail.

The loading process (S10) may be a process of loading the lead 30 on the seating part 50.

Referring FIGS. 2 and 5, the adherence part 121 of the loading device 120 may ascend in a state in which the adherence part 121 adheres the lead 30 on the table 111 of the supply buffer 110, and move and descend in the first direction so as to load the lead 30 on the seating part 150.

Here, the seating part 150 may be a standby position disposed below the vision sensor 140. That is, the adherence part 121 may move between the seating part 150 and the vision sensor 140 so as to load the lead 30 on the seating part 150.

The sensing process (S20) may be a process of photographing the lead 30 on the seating part 150 by the vision sensor 140.

Referring FIGS. 2 and 6, the adherence part 121 of the loading device 120 may return in the first direction so as to pick up the lead 30 on the supply buffer 110. Thus, the adherence part 121 is not disposed between the seating part 150 and the vision sensor 140, and the vision sensor 140 may easily photograph the lead 30 on the seating part 150.

As described above, the controller 190 may determine a defect and/or inappropriateness of the lead 30 on the basis of the vision data photographed by the vision sensor 140 (S30). In this regard, when the lead 30 is determined to be normal, the alignment process (S40) may be performed, and when the lead 30 is determined as a defect and/or inappropriateness, the collection process (S80) to be described later may be performed.

The alignment process (S40) may be a process of adjusting the seating part 150 to align the lead 30 on the basis of the vision data photographed by the vision sensor 140.

The controller 190 (see FIG. 3) may analyze the vision data photographed in the previous sensing process (S20) to generate a control command for aligning the lead 30 at a predetermined position and deliver the control command to the alignment mechanism 151. According to the control command, the alignment mechanism 151 may move the seating part 150 in the horizontal direction, and may rotate the seating part 150 at a predetermined angle around a vertical axis. In more detail, the seating part 150 may rotate at the predetermined angle by the rotation motor 152 and move by the orthogonal robot 153 in the first direction and in the second direction.

The moving process (S50 or S70) may be a process of moving the seating part 150 from the standby position to a supply position. In more detail, referring FIGS. 2 and 7, the seating part 150 may move in the first direction by the alignment mechanism 151, more particularly by the orthogonal robot 153.

The moving process (S50 or S70) may be performed between the alignment process (S40) and the supply process (S60) (S50), or performed before the collection process (S80) (S70). That is, the supply process (S60) and the collection process (S80) may be performed in a state in which the seating part 150 is disposed at the supply position.

The supply process (S60) may be a process of picking up the lead 30 from the seating part 150 to move the lead 30 to a position at which the lead 30 is connected to the electrode tab 20.

Referring FIGS. 2, 8, and 9, the supply process (S60) may include picking up the lead 30 seated on the seating part 150 by the gripper 171 of the supply device 170, and moving the gripper 171 horizontally in the second direction.

The gripper 171 of the supply device 170 may ascend in a state in which the gripper 171 holds the lead 30 on the seating part 150, and move and descend in the second direction so as to transfer the lead 30 to the position at which the lead 30 is connected to the electrode tab 20.

In this regard, the electrode assembly 10 provided with the electrode tab 20 may be sequentially supplied to a preset bonding position by a transfer system 200. In more detail, the transfer system 200 may include a table 230, which moves horizontally (e.g., in the first direction) in a state in which the electrode assembly 10 is disposed thereon, a bonding unit 210, which bonds the electrode tab 20 to the lead 30, and a support part 220 which supports the electrode tab 20 and the lead 30 from a lower side.

When the table 230 is disposed at the bonding position, the electrode tab 20 may be disposed above the support part 220 and the gripper 171 may supply the lead 30 so as to be in contact with or adjacent to the electrode tab 20. In such a state, the bonding unit 210 may descend so that the electrode tab 20 and the lead 30 are pressed and bonded to each other between the bonding unit 210 and the support part 220.

For example, the bonding unit 210 may include a mask jig and a laser unit, and the electrode tab 20 and the lead 30 may be laser welded to each other. Configurations and operations for performing the laser welding are the well-known art and thus, the detailed description thereof will be omitted.

When the bonding of the electrode tab 20 to the lead 30 is completed, the gripper 171 may release the lead 30 and return in the second direction.

After the alignment process (S40) is performed, the seating part 150, on which the lead 30 is seated, moves by a preset distance in the first direction in the moving process (S50), and the gripper 171 holding the lead 30 moves by a preset distance in the second direction in the supply process (S60), so that the lead 30 after the alignment may be supplied to a predetermined position at which the lead 30 is connected to the electrode tab 20.

Accordingly, the manufacturing quality of the electrode assembly 10 may be improved. There is also an advantage that even when the specification, etc., of the lead 30 to be stocked in the supply buffer 110 changes, the alignment may be automatically performed without stopping the equipment.

When the lead 30 is determined as a defect and/or inappropriateness in the sensing process (S20), the collection process (S80) may be performed. That is, the collection process (S80) may be a process of picking up and collecting the lead 30 when the lead 30 is determined as a defect and/or inappropriateness on the basis of the vision data photographed by the vision sensor 40.

In more detail, the gripper 171 may pick up the lead 30 on the seating part 150 that is the supply position, so as to collect the lead 30 in the collecting box 160 instead of supplying the lead 30 to the position at which the lead 30 is connected to the electrode tab 20. Accordingly, the defective or inappropriate lead 30 may be prevented from being provided in the electrode assembly 10, and the quality of the electrode assembly 10 may be further improved.

Alternatively, even when the lead 30 is determined as a defect and/or inappropriateness, it may be possible to perform the alignment process (S40) unconditionally and then, perform the collection process (S80).

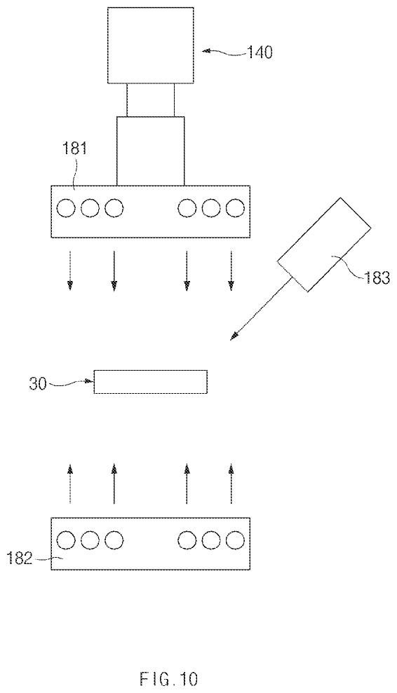

FIG. 10 is a view for explaining a lead supply system according to another embodiment of the present invention.

The lead supply system according to this embodiment is the same as an embodiment described above except that a plurality of light units 181, 182 and 183 are further included. Thus, duplicate description is omitted and the description will be focused on differences.

Referring to FIGS. 2 and 10 together, the lead supply system according to this embodiment may further include at least one of an overhead light unit 181, which emits light onto a top surface of the lead 30 on the seating part 150, or a backlight unit 182 which emits the light onto a bottom surface of the lead 30 on the seating part 150. The lead supply system may further include a concentrative light unit 183.

The overhead light unit 181, the backlight unit 182, and the concentrative light unit 183 may emit light toward the lead 30 when the vision sensor 140 photographs the lead 30 on the seating part 150. That is, the sensing process (S20) (see FIG. 4) described above may be performed in a state in which the light is emitted toward the lead 30.

The overhead light unit 181 may be a coaxial light unit. The overhead light unit 181 may be disposed above the seating part 150, particularly above the seating part 150 that is a standby position. That is, the overhead light unit 181 may be provided in the vision sensor 140 or disposed to be adjacent to the vision sensor 140. The overhead light unit 181 may be connected to the connection part 142 together with the vision sensor 140 so as to be supported by the frame body 131.

The backlight unit 182 may be disposed below the seating part 150, particularly below the seating part 150 that is the standby position. Alternatively, the backlight unit 182 may be provided in the seating part 150.

Due to the overhead light unit 181, shadows may be prevented from occurring on the lead 30 due to peripheral equipment, etc., and light reflection may be prevented from excessively occurring on the lead 30. Due to the backlight unit 182, an outline of the lead 30 may become clearer.

Thus, due to the overhead light unit 181 and the backlight unit 182, an accurate outline of the lead 30 may be detected from the vision data photographed by the vision sensor 140, and the lead 30 may be more precisely aligned.

The concentrative light unit 183 may be provided toward the seating part 150 and concentratively emit light onto a partial area on the lead 30. That is, the concentrative light unit 183 may concentratively emit light onto a narrower area on the top surface of the lead 30 when compared to the overhead light unit 181. The area onto which the light of the concentrative light unit 183 is concentratively emitted may be disposed inward from the outline of the lead 30 so as not to interfere with the detection of the outline of the lead 30.

The concentrative light unit 183 may be disposed to be adjacent to the vision sensor 140. The concentrative light unit 183 may be connected to the connection part 142 together with the vision sensor 140 so as to be supported by the frame body 131. The concentrative light unit 183 may be disposed to be inclined.

Due to the concentrative light unit 183, the color property (e.g., chroma) of the lead 30 and the material according to the color property may be accurately determined on the basis of the vision data photographed by the vision sensor 140. Thus, it may be more accurately determined whether the material of the lead 30 matches polarity information of the electrode tab 20.

The description of the present invention is intended to be illustrative, and various changes and modifications can be made by those of ordinary skill in the art to which the present invention pertains, without departing from the spirit and scope of the present invention as defined by the appended claims.

Therefore, the embodiments set forth herein are to describe the technical spirit of the present invention and not to limit. The scope of the technical spirit of the present invention is not limited by the embodiments.

Moreover, the protective scope of the present invention should be determined by reasonable interpretation of the appended claims and all technical concepts coming within the equivalency range of the present application should be interpreted to be in the scope of the right of the present application.

[Description of the Symbols]

| | |
|---|---|
| 10: Electrode assembly | 20: Electrode tab |
| 30: Lead | 100: Lead supply system |
| 110: Supply buffer | 120: Loading device |
| 130: Support frame | 140: Vision sensor |
| 150: Seating part | 151: Alignment mechanism |
| 152: rotation motor | 153: Orthogonal robot |
| 160: Collecting box | 170: Supply device |
| 171: Gripper | 172: Orthogonal robot |
| 181: Overhead light unit | 182: Backlight unit |
| 183: Concentrative light unit | 190; Controller |

1. A lead supply system configured to supply a lead so as to be connected to an electrode tab, the lead supply system comprising:
a seating part on which the lead is seatable;
a vision sensor configured to photograph the lead at an upper side of the seating part;
an alignment mechanism configured to adjust the seating part so as to align the lead on the basis of vision data photographed by the vision sensor; and
a supply device configured to pick up the lead from the seating part to supply the lead to a position at which the lead is to be connected to the electrode tab.

2. The lead supply system of claim 1, further comprising a collecting box in which the lead is collected by the supply device when the lead is determined as to be defective or to be inappropriate for the electrode tab on the basis of the vision data.

3. The lead supply system of claim 1, wherein the alignment mechanism comprises:
a rotation motor disposed below the seating part and configured to rotate the seating part around a vertical axis; and
an orthogonal robot configured to move the rotation motor horizontally in first and second directions perpendicularly crossing each other.

4. The lead supply system of claim 1, wherein the alignment mechanism is configured to move the seating part between a standby position disposed below the vision sensor and a supply position spaced apart from the standby position in a first direction, and
wherein the supply device is configured to pick up the lead when the seating part is disposed at the supply position.

5. The lead supply system of claim 4, wherein the supply device comprises:
a gripper configured to hold the lead; and
an orthogonal robot configured to move the gripper in a second direction perpendicularly crossing the first direction and in a vertical direction.

6. The lead supply system of claim 4, further comprising a loading device configured to load the lead on the seating part when the seating part is disposed at the standby position.

7. The lead supply system of claim 6, wherein the loading device comprises:
an adherence part configured to adhere the lead at an upper side of the adherence part;
an elevation actuator configured to elevate the adherence part; and
a uniaxial actuator configured to move the elevation actuator horizontally.

8. The lead supply system of claim 1, further comprising at least one of an overhead light configured to emit light onto the lead from above the seating part, or a backlight unit provided in the seating part or disposed below the seating part.

9. The lead supply system of claim 8, further comprising a concentrative light directed toward the seating part and configured to concentratively emit light onto a partial area on the lead.

10. A method for controlling a lead supply system that supplies a lead to be connected to an electrode tab, the method comprising:
loading the lead on a seating part;
photographing the lead on the seating part by a vision sensor;
adjusting the seating part to align the lead on the basis of vision data photographed by the vision sensor; and
picking up the lead from the seating part to move the lead to a position at which the lead is connected to the electrode tab.

11. The method of claim 10, further comprising collecting the lead when the lead is determined to be defective or inappropriate for the electrode tab on the basis of the vision data.

12. The method of claim 10, further comprising moving the seating part in a first direction between a location where adjusting the seating part occurs and a location where picking up the lead occurs.

13. The method of claim 12, wherein picking up the lead comprises:
picking up the lead seated on the seating part by a gripper; and
moving the gripper horizontally in a second direction perpendicularly crossing the first direction.

14. The method of claim 10, wherein photographing the lead is performed in a state in which light is emitted toward the lead.
